(19) United States
(12) Patent Application Publication
(10) Pub. No.: US 2024/0260107 A1
(43) Pub. Date: Aug. 1, 2024

(54) SYSTEMS AND METHODS FOR PROVIDING MULTIMEDIA SERVICES TO MULTIPLE NETWORKS

(71) Applicant: Verizon Patent and Licensing Inc., Basking Ridge, NJ (US)

(72) Inventors: Jun Yuan, Cranbury, NJ (US); Hongkun Li, Basking Ridge, NJ (US); Deepa Jagannatha, Bridgewater, NJ (US)

(73) Assignee: Verizon Patent and Licensing Inc., Basking Ridge, NJ (US)

(21) Appl. No.: 18/161,047

(22) Filed: Jan. 28, 2023

(51) Int. Cl. H04W 76/15; H04W 76/12

(52) U.S. Cl. CPC H04W 76/15; H04W 76/12; H04W 88/16

(57) ABSTRACT

A system described herein may receive, from a User Equipment (“UE”) via a first network, a request to establish a communication session. The system may determine, based on one or more attributes of the request, that the requested communication session should be established between the UE and a gateway device that is communicatively coupled to a second network. The system may establish, based on the determining, the communication session between the UE and the gateway device. The UE may output communications to the gateway device via the established communication session, and the gateway device may forward the communications received via the communication session to an Internet Protocol (“IP”) Multimedia Subsystem (“IMS”) core of the second network. In this manner, the UE connected to the first network may receive multimedia services provided by the IMS core of the second network.

### BACKGROUND

Some networks, such as wireless networks, may include or may be communicatively coupled to systems that provide multimedia services or other enhanced messaging services, such as Internet Protocol (“IP”) Multimedia Subsystem (“IMS”) networks. Other networks, such as private networks, roaming networks, etc. may not offer such services.

### BRIEF DESCRIPTION OF THE DRAWINGS

FIG. 1 illustrates an example overview of one or more embodiments described herein;

FIG. 2 illustrates an example of different tunnels between an IMS Interworking Gateway of some embodiments and one or more networks;

FIG. 3 illustrates example criteria that may be maintained by a particular network to identify IMS-bound traffic, in accordance with some embodiments;

FIG. 4 illustrates an example of routing IMS-bound/originated traffic and non-IMS-bound traffic, in accordance with some embodiments;

FIG. 5 illustrates example information that may be maintained by an IMS Interworking Gateway of some embodiments;

FIG. 6 illustrates an example signal flow for routing IMS-bound uplink traffic, in accordance with some embodiments;

FIG. 7 illustrates an example signal flow for routing IMS-originated downlink traffic, in accordance with some embodiments;

FIG. 8 illustrates an example signal flow for routing non-IMS-bound uplink traffic, in accordance with some embodiments;

FIG. 9 illustrates an example process for routing IMS-bound traffic from one network to another network, in accordance with some embodiments;

FIG. 10 illustrates an example environment in which one or more embodiments, described herein, may be implemented;

FIG. 11 illustrates an example arrangement of a radio access network (“RAN”), in accordance with some embodiments; and

FIG. 12 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

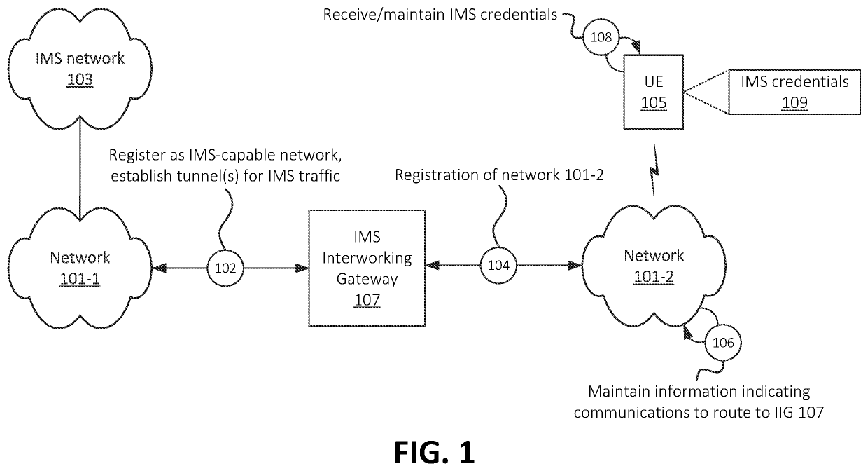

Embodiments described herein provide for the use of multimedia services associated with a particular network by one or more other networks. In this manner, networks that do not include such functionality may be able to leverage the multimedia functionality of other networks, without the need to deploy their own devices or systems to provide such functionality. As shown in FIG. 1, for example, network 101-1 may include and/or may be communicatively coupled to IMS network 103. IMS network 103 may provide or facilitate multimedia services, such as voice call setup services, Rich Communication Services (“RCS”), and/or other suitable multimedia services. IMS network 103 may include one or more Call Session Control Functions (“CSCFs”), such as an Interrogating CSCF (“I-CSCF”), a Proxy CSCF (“P-CSCF”), and/or other devices or systems that provide or facilitate multimedia services. IMS network 103 and/or one or more elements thereof may operate according to Session Initiation Protocol (“SIP”) messaging, which may include requests to establish voice calls or to provide other multimedia features.

In some embodiments, network 101-1 may be or may include a core of a wireless network. For example, network 101-1 may be or may include an Evolved Packet Core (“EPC”), a Fifth Generation (“5G”) Core (“5GC”), and/or some other type of wireless network core. One or more elements of network 101, such as a User Plane Function (“UPF”), a Packet Data Network (“PDN”) Gateway (“PGW”), or some other suitable device or system may communicate with IMS network 103 (e.g., with a P-CSCF or other element of IMS network 103) via one or more suitable interfaces. In this sense, network 101-1 may be an “IMS-capable” network.

On the other hand, network 101-2 may not be an IMS-capable network. For example, network 101-2 may not have an interface with IMS network 103 (or some other IMS network). Network 101-2 may be a core of a different wireless network than network 101-1. For example, network 101-1 may be operated, owned, provided, etc. by a first network operator, while network 101-2 may be operated, owned, provided, etc. by a second network operator. As another example, network 101-2 may be a private network that utilizes some of the same resources as network 101-1. For example, network 101-1 may include a set of wireless network infrastructure, such as base stations, radios, antennas, a RAN, etc., and network 101-2 may utilize some of the wireless network infrastructure while maintaining a separate set of devices or systems to implement a separate core network from network 101-1.

As shown, network 101-2 may be communicatively coupled to one or more User Equipment (“UEs”), such as UE 105 (e.g., a mobile telephone, a tablet, an Internet of Things (“IoT”) device, a wearable device, etc.). Although network 101-2 is not an IMS-capable network, UE 105 may nevertheless be able to receive multimedia services (e.g., IMS services) while connected to network 101-2, as discussed herein.

In accordance with some embodiments, for example, networks 101-1 and 101-2 may be communicatively coupled to IMS Interworking Gateway (“IIG”) 107. IIG 107 may, for example, be an element of network 101-1 in some embodiments, may be an element of network 101-2, and/or may be a separate device or system that is able to be reached by networks 101-1 and 101-2 (e.g., via another network such as the Internet). As discussed herein, IIG 107 may facilitate the providing of multimedia services of an IMS-capable network, such as network 101-1, to one or more other networks, such as network 101-2.

As shown, network 101-1 may register (at 102) with IIG 107 as an IMS-capable network. For example, IIG 107 may include or implement an application programming interface (“API”), a web portal, or other suitable interface via which network 101-1 and/or some other associated device or system (e.g., a workstation, an administrator console, a network management application, etc.) may communicate with IIG 107 to register with network 101-1.

The registration may include indicating, to IIG 107, that network 101-1 has the capability to provide multimedia services, process SIP messaging, etc. The registering (at 102) of network 101-1 with IIG 107 may include providing locator information for one or more communication endpoints of network 101-1. For example, network 101-1 may provide (at 102) IP addresses or other identifiers of one or more UPFs, PGWs, routers, gateways, or other suitable communication endpoints that may communicate with IIG 107 in order to perform one or more operations described herein. Network 101-1 and IIG 107 may additionally establish one or more tunnels (e.g., a General Packet Radio Service (“GPRS”) Tunneling Protocol (“GTP”) tunnel, an IP tunnel, or some other type of tunnel) or other types of communication sessions. As discussed below, such tunnels may be used to provide traffic, received from network 101-2 to network 101-1, and vice versa. As discussed below, network 101-1 may provide different endpoint information (e.g., associated with different UPFs, different PGWs, etc.) as well as criteria, conditions, etc. associated with each different endpoint. In this manner, network 101-1 may further provide differentiated levels of service (e.g., according to different Quality of Service (“QoS”) levels, where each endpoint may be associated with a different level of service) and/or perform load balancing among the different endpoints based on factors associated with such criteria, conditions, etc.

Registering (at 102) with IIG 107 may also include exchanging authentication and/or authorization information, such as one or more keys, authentication tokens, and/or other suitable mechanisms by which network 101-1 may authenticate and authorize communications from IIG 107, and vice versa. Similarly, network 101-2 may also register (at 104) with IIG 107, which may include exchanging authentication and/or authorization information by which network 101-2 may authenticate and authorize communications from IIG 107, and vice versa. Networks 101-1 and 101-2 may also provide (at 102 and 104, respectively) one or more network identifiers that IIG 107 may use to identify networks 101-1 and 101-2, such as one or more Public Land Mobile Network (“PLMN”) identifiers or other suitable network identifiers.

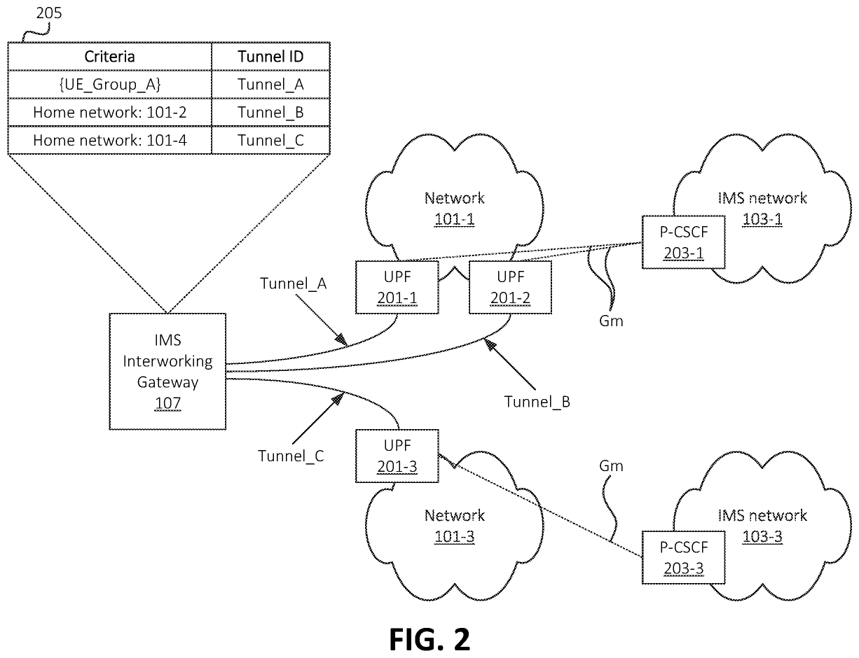

FIG. 2 illustrates an example of the result of multiple networks 101 (i.e., networks 101-1 and 101-3, in this example) registering (e.g., at 102) as IMS-capable networks with IIG 107. As shown, for example, network 101-1 may have registered two endpoints (e.g., UPFs 201-1 and 201-2) with IIG 107, and network 101-3 may have registered one endpoint (e.g., UPF 201-3) with IIG 107. As such, network 101-1 and IIG 107 may have established two tunnels (e.g., Tunnel_A between UPF 201-1 and IIG 107 and Tunnel_B between UPF 201-2 and IIG 107), and network 101-3 and IIG 107 may have established another tunnel (e.g., Tunnel_C between UPF 201-3 and IIG 107). As discussed above, UPFs 201 are one example of a type of endpoint that may be used by networks 101. In some embodiments, some or all of the endpoints may be another type of device or system, such as a PGW, a router, a gateway, etc.

As further shown, the endpoints of networks 101 may be communicatively coupled to a respective IMS network 103. For example, UPFs 201-1 and 201-2, of network 101-1, may be communicatively coupled to IMS network 103-1 via a Gm interface (e.g., between UPFs 201-1/201-2 and P-CSCF 203-1 of IMS network 103-1), and UPF 201-3 may be communicatively coupled to IMS network 103-3 via a Gm interface (e.g., between UPF 201-3 and P-CSCF 203-3 of IMS network 103-3). In some embodiments, the designated endpoints of respective networks 101 may be communicatively coupled to a respective IMS network 103 via some other type of interface or route.

As further shown, IIG 107 may maintain information (e.g., represented by data structure 205) indicating different criteria associated with different tunnels between IIG 107 and respective endpoints. In the example shown here, particular UEs 105 or groups of UEs 105 may be one criteria associated with a particular tunnel. For example, a group of UEs 105, represented as “{UE_Group_A},” may be associated with Tunnel_A. The group of UEs 105 may be indicated as a set of UE identifiers (e.g., International Mobile Subscriber Identity (“IMSI”) values, International Mobile Station Equipment Identity (“IMEI”) values, Subscription Permanent Identifier (“SUPI”) values, Globally Unique Temporary Identifier (“GUTI”) values, Mobile Directory Numbers (“MDNs”), IP addresses, and/or other suitable identifiers), classifications or categories (e.g., “first responder,” “enterprise,” etc.), UE device type (e.g., mobile phone, IoT device, a particular make and/or model, etc.) and/or other suitable UE identifiers or attributes.

As further shown, home network may be another criteria based on which different tunnels may be associated. A “home” network may be a particular network 101 that maintains provisioning information, charging and/or usage information, authentication and/or authorization information, etc. associated with one or more UEs 105. Data structure 205 may include, for example, a PLMN identifier or other suitable identifier of one or more networks 101. In this example, network 101-2 may be associated with Tunnel_B, and network 101-4 may be associated with Tunnel_C. While UE identifiers or groups and network identifiers are indicated as example criteria in this figure, other identifiable attributes or parameters may be used as criteria in accordance with some embodiments.

Returning to FIG. 1, as part of the registration (at 104) of network 101-2 with IIG 107, and/or based on such registration, network 101-2 may receive or maintain (at 106) information indicating communications to route to IIG 107. For example, network 101-2 may receive one or more policies, criteria, conditions, etc. indicating attributes of traffic to route to IIG 107. In some embodiments, IIG 107 may provide such policies, criteria, conditions, etc. Additionally, or alternatively, an administrator or other entity associated with network 101-2 may specify such policies, criteria, conditions, etc.

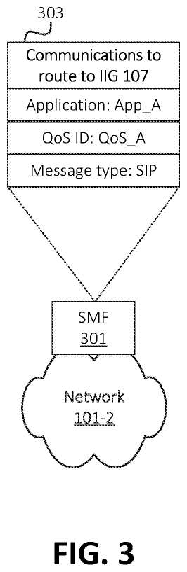

As shown in FIG. 3, the policies, criteria, conditions, etc. may be maintained or received by one or more elements of network 101-2, such as Session Management Function (“SMF”) 301. In some embodiments, such policies, criteria, conditions, etc. may be received or maintained by one or more other elements of network 101-2, such as a Policy Control Function (“PCF”), a Policy Charging and Rules Function (“PCRF”), a Unified Data Management function (“UDM”), a Home Subscriber Server (“HSS”), and/or other suitable device or system. The policies, criteria, conditions, etc. maintained by network 101-2 (e.g., SMF 301) are represented in FIG. 3 as data structure 303. In this example, data structure 303 indicates attributes of traffic (e.g., uplink traffic received from one or more UEs 105 communicatively coupled to network 101-2) that should be routed to IIG 107 (e.g., as opposed to some other device or system of network 101-2, such as a respective UPF, PGW, etc. of network 101-2). The attributes may include attributes that may be identifiable with respect to particular traffic, such as attributes that are able to be identified by analyzing header information of traffic received from UEs 105. Additionally, or alternatively, some or all of the attributes may include attributes that are able to be identified by analyzing a payload of traffic received from UEs 105 (e.g., by Deep Packet Inspection (“DPI”) or other suitable technique).

Data structure 303 may indicate, for example, that traffic associated with a particular application (e.g., traffic including a particular application identifier, represented as “App_A”), such as a voice calling application, a videoconferencing application, a messaging application, etc., should be routed to IIG 107. As another example, data structure 303 may indicate that traffic associated with a particular QoS level or QoS identifier (e.g., a 5G QoS Identifier (“5QI”) value, a QoS Class Identifier (“QCI”) value, etc.), represented in the figure as “QoS_A.” As yet another example, data structure 303 may indicate that particular types or protocols of messages should be routed to IIG 107. For example, SIP protocol messages (e.g., messages with a header type indicating the SIP protocol, messages with a SIP identifier associated with UE 105, etc.) may be indicated as types of messages that should be routed to IIG 107. In some embodiments, other types of criteria may be used to identify communications that should be routed to IIG 107, such as an identifier or group of a respective UE 105 from which the traffic is received, UE location, UE Route Selection Policy (“URSP”) rules, traffic descriptors, traffic type such as voice call, etc.). The example criteria discussed may be applied using “OR” logic, in which traffic meeting one such criteria may be routed to IIG 107. In some embodiments, other logic may be used in order to identify traffic that meets the indicated criteria.

Returning to FIG. 1, UE 105 may receive and/or maintain (e.g., at 108) a set of IMS credentials 109. IMS credentials 109 may include, for example, a username (e.g., a SIP identifier), a set of authentication credentials (e.g., which may be used by one or more particular IMS networks 103) to authenticate UE 105, etc.), and/or other suitable information that may be used by one or more IMS networks 103 to identify or authenticate UE 105. In some embodiments, IMS credentials 109 may be maintained or provided by an application, API, software development kit (“SDK”), or the like that is installed on UE 105, executed by UE 105, etc. As discussed below, such credentials may be used by UE 105 when initiating communications (e.g., voice calls or other suitable types of communications) for which multimedia services, provided by a device or system other than network 101-2 to which UE 105 is connected, should be provided.

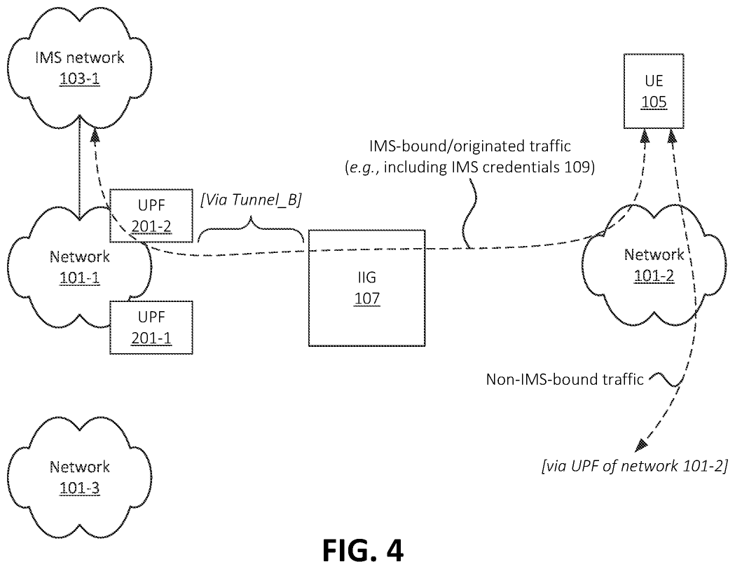

As shown in FIG. 4, IMS-bound traffic outputted by and/or originated from UE 105 may be routed to IMS network 103-1, while non-IMS-bound traffic outputted by and/or originated from UE 105 may be routed via other devices or systems (e.g., a UPF of network 101-2). As discussed above, for example, SMF 301 or some other device or system of network 101-2 may identify traffic or communication sessions that are IMS-bound (e.g., that should be routed to IIG 107 as opposed to a UPF or other device or system of network 101-2), which may include identifying traffic or communication session requests that include IMS credentials 109, an indication of a particular protocol (e.g., SIP or some other suitable protocol), etc. As discussed above, SMF 301 may identify attributes of the traffic or communication session request to criteria maintained in example data structure 303 to determine whether the traffic or communication session request meets such criteria.

Network 101-2 may accordingly establish a particular communication session for the IMS-bound traffic, such as a protocol data unit (“PDU”) session between UE 105 and IIG 107, via which the IMS-bound traffic may be routed. In some embodiments, network 101-2 may provide an identifier of network 101-2 (e.g., a PLMN identifier) to IIG 107, such that IIG 107 maintains information indicating that the PDU session and/or UE 105 are associated with network 101-2 as a home network. Additionally, or alternatively, in some embodiments, the traffic from UE 105 may itself include the identifier of network 101-2 as the home network of UE 105.

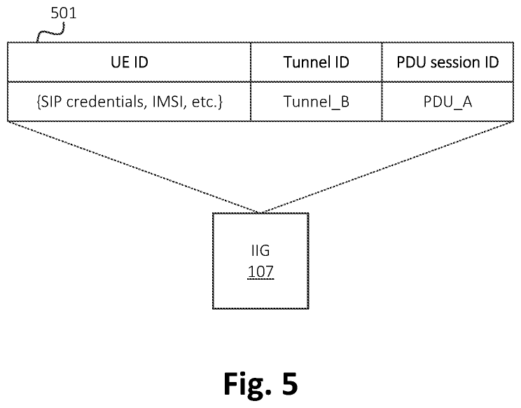

IIG 107 may identify (e.g., based on the home network of UE 105 or other criteria discussed above with respect to data structure 205) that traffic received from UE 105 (e.g., traffic received the particular PDU session) should be routed to UPF 201-2 of network 101-1. For example, IIG 107 may identify that a previously established tunnel (e.g., Tunnel_B) between IIG 107 and UPF 201-2 should be used for such traffic, and/or that Tunnel_B should be established between IIG 107 and UPF 201-2 in order to accommodate such traffic. As shown in FIG. 5, IIG 107 may maintain information (represented as data structure 501) associating an identifier of UE 105 with an identifier of the established tunnel (e.g., Tunnel_B) and/or an identifier of the PDU session between IIG 107 and UE 105 (represented as “PDU_A”).

When receiving the traffic (e.g., via Tunnel_B), UPF 201-2 may identify that such traffic should be routed to IMS network 103-1 based on identifying that the traffic includes a particular protocol (e.g., SIP), a particular identifier format (e.g., a SIP identifier), and/or other suitable criteria. UPF 201-2 may further maintain information associating Tunnel_B with a particular identifier of UE 105, such as a SIP identifier and/or other suitable identifier.

Similarly, in the downlink direction (e.g., traffic outputted by IMS network 103-1 to UE 105), UPF 201-2 may identify that the traffic should be routed to IIG 107 based on an identifier of UE 105 (e.g., a SIP identifier or other suitable identifier) indicated in the downlink traffic. IIG 107 may further identify that a destination of the traffic is UE 105, and may identify that the traffic should be routed to UE 105 via a particular communication session (e.g., a previously established PDU session) between IIG 107 and UE 105. In this manner, multimedia traffic (e.g., IMS-bound and/or IMS-originated traffic) may be routed between UE 105 of network 101-2 and IMS network 103-1 of network 101-1, while other traffic may be routed via a UPF or other suitable element of network 101-2.

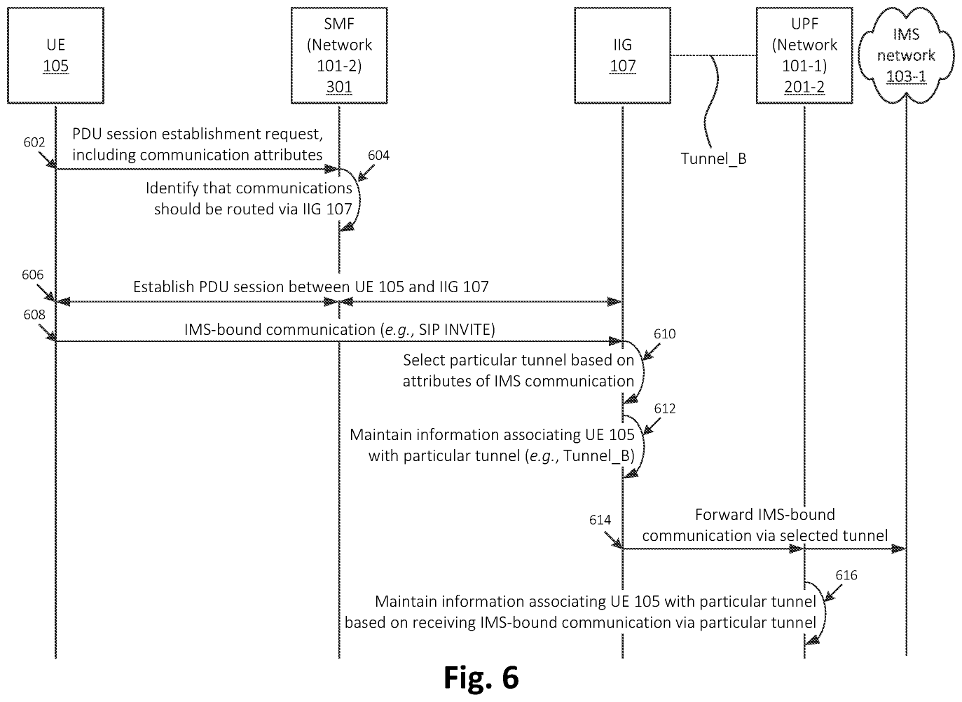

FIG. 6 illustrates an example signal flow for routing IMS-bound uplink traffic, in accordance with some embodiments. As shown, UE 105 may initiate (at 602) a PDU session establishment (e.g., which may include outputting a PDU session establishment request), including providing one or more communication attributes. The PDU session establishment request may be generated and/or outputted by an application executing on UE 105, such as a messaging application. The messaging application may be configured to, for example, request a PDU session for one or more communication sessions, such as voice call sessions, videoconferencing sessions, etc. As discussed above, the communication attributes may include an indicator of a particular application (e.g., an identifier of the application requesting establishment of the PDU session), an indicator of an application or service type (e.g., voice call, videoconferencing session, etc.), a QoS level identifier, a traffic descriptor, a URSP rule, and/or other suitable attributes.

Assume, in this example, that UE is communicatively coupled to network 101-2. Accordingly, SMF 301, of network 101-2, may receive the PDU session establishment request. In accordance with some embodiments (e.g., as discussed above with respect to data structure 303), SMF 301 may identify (at 604) that communications, associated with the PDU session request (e.g., associated with the PDU session, once established) should be routed to IIG 107 (e.g., as opposed to a UPF or other element of network 101-2). Accordingly, SMF 301 may communicate with UE 105 and IIG 107 to establish (at 606) a particular PDU session between UE 105 and IIG 107. For example, SMF 301 may provide an IP address or other suitable locator information of UE 105 to IIG 107, and/or may provide an IP address or other suitable locator information of IIG 107 to UE 105. While discussed in the context of a PDU session, in some embodiments the communication session between UE 105 and IIG 107 may be a different type of communication session, such as an IP-based communication session or some other type of communication session.

Once established (at 606), UE 105 and IIG 107 may be able to communicate via the PDU session. For example, UE 105 may output (at 608) an IMS-bound communication via the PDU session. The IMS-bound communication may include an indication of a particular protocol (e.g., SIP), a particular message type (e.g., a SIP INVITE message), a particular format of identifier (e.g., a SIP identifier or SIP credentials), and/or other suitable information that may be used by IIG 107 to determine how to handle or route the IMS-bound communication. For example, as discussed above, IIG 107 may maintain information (e.g., data structure 205) indicating criteria based on which communications should be routed via particular tunnels, such as Tunnel_B between IIG 107 and UPF 201-2 of network 101-1 and/or one or more other tunnels.

Accordingly, IIG 107 may select (at 610) a particular tunnel (i.e., Tunnel_B, in this example) via which the IMS-bound communication should be routed, which may include determining that the communication should be routed to UPF 201-2 of network 101-1 (e.g., an endpoint of the tunnel). IIG 107 may also maintain (at 612) information (e.g., data structure 501) associating UE 105 and/or the established PDU session with the particular tunnel. IIG 107 may proceed to forward (at 614) the IMS-bound communication via the particular tunnel. As discussed above, UPF 201-2 (e.g., an endpoint of the tunnel) may receive the communication, determine that the communication should be routed to IMS network 103-1, and may accordingly route the communication to IMS network 103-1. IMS network 103-1 may perform further suitable processing, such as routing the communication to a telephony application server (“TAS”), establishing or modifying a voice call session, notifying one or more other UEs 105 that UE 105 is requesting a voice call, etc.

In some embodiments, UPF 201-2 may also maintain (at 616) information associating UE 105 with the particular tunnel (e.g., Tunnel_B). For example, based on receiving (at 614) the communication via the particular tunnel, UPF 201-2 may identify an identifier of UE 105 indicated in the communication (e.g., a SIP identifier or some other identifier associated with UE 105), and may associate such identifier with the particular tunnel. As discussed below, UPF 201-2 may use such information to route downlink communications, received from IMS network 103-1 (e.g., IMS-originated traffic), to UE 105.

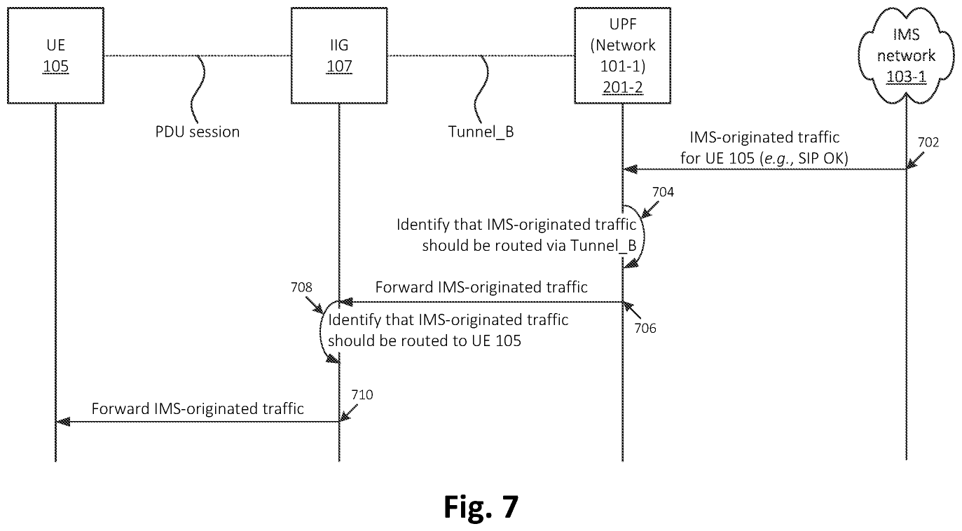

FIG. 7 illustrates an example signal flow for routing IMS-originated downlink traffic, in accordance with some embodiments. As shown, IMS network 103-1 may output (at 702) IMS-originated traffic to UPF 101-1. The traffic may include an identifier of UE 105, such as a SIP identifier or other suitable identifier. In some embodiments, the traffic may include a SIP message, such as a SIP OK message. UPF 201-2 may identify (at 704) that the IMS-originated traffic should be routed via Tunnel_B. For example, as discussed above, UPF 201-2 may identify, based on previously maintained (e.g., at 616) information, that traffic destined for UE 105 should be routed via Tunnel_B (e.g., to IIG 107). Accordingly, UPF 201-2 may forward (at 706) the IMS-originated traffic to IIG 107. IIG 107 may identify (at 708), based on previously maintained (e.g., at 612) information, that the received IMS-originated traffic should be routed to UE 105 (e.g., via a PDU session between IIG 107 and UE 105), and may accordingly forward (at 710) the IMS-originated traffic to UE 105. An application of UE 105, such as an IMS-capable application, a voice call application, etc. may accordingly process and/or handle the IMS-originated traffic, such as by participating in a voice call, videoconferencing session, etc.

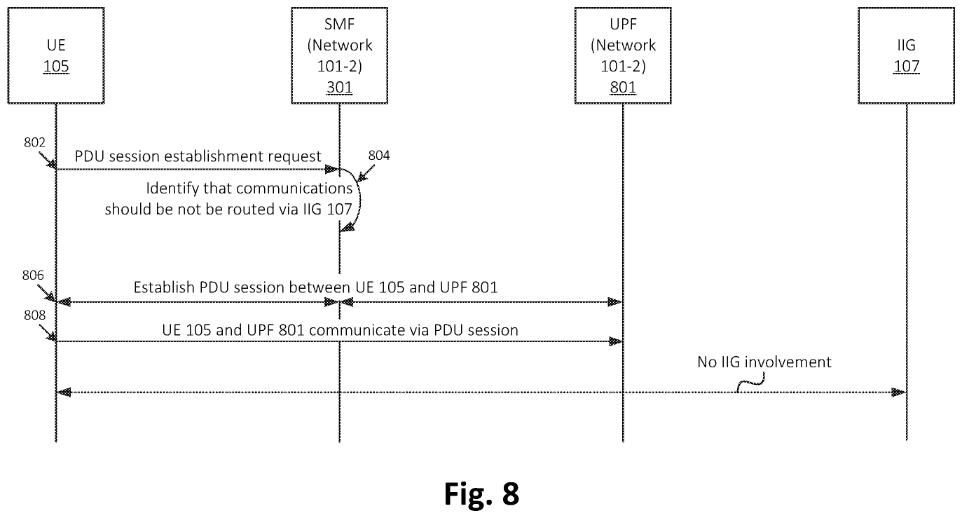

FIG. 8 illustrates an example signal flow for routing non-IMS-bound uplink traffic, in accordance with some embodiments. For example, as discussed above, not all traffic outputted by or otherwise originated by UE 105 may be IMS-bound traffic. As shown, UE 105 may output (at 802) a PDU session establishment request. SMF 301 may identify (at 804) that communications, associated with the requested PDU session, should not be routed via IIG 107. For example, SMF 301 may determine that attributes of the request do not match a particular set of attributes (e.g., as discussed above with respect to data structure 303), may determine that communications associated with the requested PDU session are not IMS-bound, and/or may otherwise not determine that communications associated with the requested PDU session should be routed to IIG 107.

Based on determining (at 804) that the requested PDU session should not be routed to IIG 107 (and/or based on not determining that the requested PDU session should be routed to IIG 107), SMF 301 may establish (at 806) the requested PDU session between UE 105 and one or more other elements of network 101-2, such as a particular UPF 801. Accordingly, UE 105 may communicate (at 808) via the established (at 806) PDU session. Since SMF 301 did not determine (at 804) that the PDU session should be established between UE 105 and IIG 107, there may be no involvement of IIG 107 with this particular PDU session (e.g., IMS services may not be requested or provided for such communications). In this manner, network 101-2 may continue to handle or route non-IMS-bound communications using any suitable routing or processing technique, while also being able to leverage multimedia services provided by an IMS network (e.g., IMS network 103-1) when such services are called for.

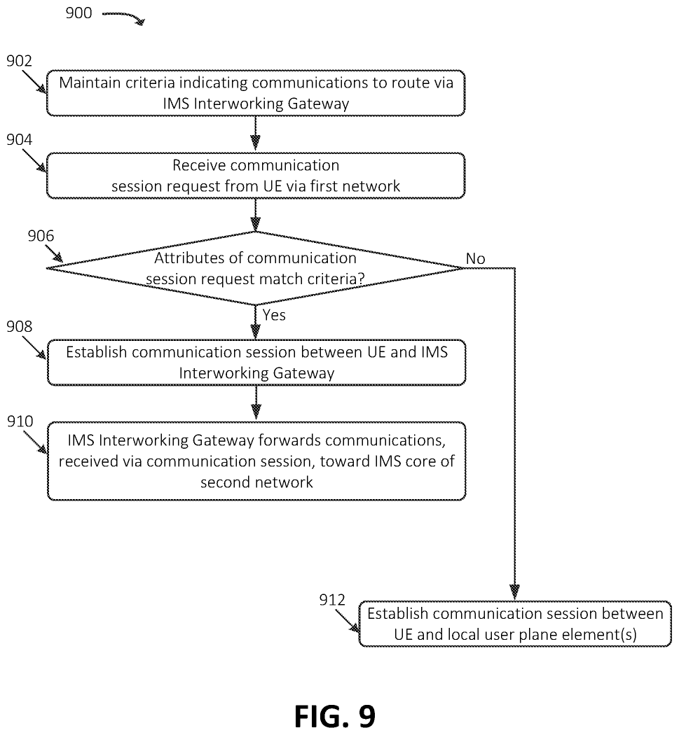

FIG. 9 illustrates an example process 900 for routing IMS-bound traffic from one network to another network. In some embodiments, some or all of process 900 may be performed by SMF 301. In some embodiments, one or more other devices may perform some or all of process 900 in concert with, and/or in lieu of, SMF 301 (e.g., IIG 107).

As shown, process 900 may include maintaining (at 902) criteria indicating communications to route via IIG 107. For example, as discussed above, SMF 301 may receive or maintain such information in data structure 303.

Process 900 may further include receiving (at 904) a communication session request from UE 105. UE 105 may, for example, be communicatively coupled to a first network 101 that includes SMF 301. For example, UE 105 may be wirelessly connected to a RAN that is communicatively coupled to a core network that includes SMF 301.

Process 900 may additionally include determining (at 906) whether attributes of the communication session request match the criteria indicating communications to rout via IIG 107. For example, the communication session request may indicate a particular protocol (e.g., SIP, Transmission Control Protocol (“TCP”), Hypertext Transfer Protocol (“HTTP”), etc.) and/or other attributes of the requested communication session. If the identified attributes match the criteria (at 906—YES), then the communication session request may be associated with IMS-bound traffic, multimedia traffic, and/or other types of traffic that should ultimately be forwarded to an IMS network 103.

In such a scenario, process 900 may include establishing (at 908) the requested communication session between UE 105 and IIG 107. For example, SMF 301 may communicate with UE 105 and/or IIG 107 in order to establish the communication session, such as a PDU session. As discussed above, SMF 301 may notify UE 105 of an IP address or other locator information associated with IIG 107, and/or may notify IIG 107 of an IP address or other locator information associated with UE 105. UE 105 may maintain information indicating that IIG 107 is an endpoint of the requested PDU session, and may accordingly output traffic (e.g., IMS-bound traffic, such as one or more SIP messages or other suitable messages) via such PDU session (e.g., to IIG 107).

IIG 107 may accordingly forward (at 910) such communications toward a particular IMS network 103 of a second network 101. For example, IIG 107 may forward communications, received via the PDU session, via one or more tunnels and/or may otherwise forward such communications to one or more other networks 101 (or to particular endpoints within such networks 101, such as particular UPFs 201). As discussed above, IIG 107 may maintain information indicating which network 101, UPF 201, tunnel, or other endpoint should receive traffic meeting certain attributes or criteria. In this manner, different levels of service (e.g., associated with different UPFs 201 or tunnels) may be provided, and/or load balancing between different UPFs or tunnels may be performed.

If, on the other hand, attributes of the communication session request do not match the criteria of communications to forward to IIG 107 (at 906—NO), then process 900 may include establishing (at 912) the requested communication session between UE 105 and one or more local user plane elements, such as UPF 801 of the first network 101 (e.g., the same network 101 with which SMF 301 is associated). That is, SMF 301 may forgo determining that the requested communication session should be associated with UE 105 and IIG 107.

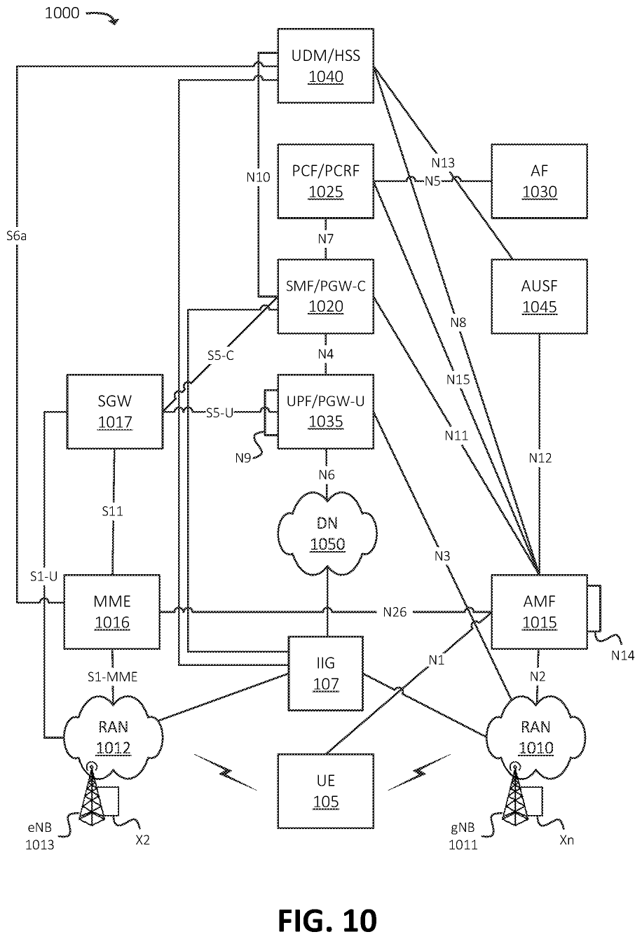

FIG. 10 illustrates an example environment 1000, in which one or more embodiments may be implemented. In some embodiments, environment 1000 may correspond to a Fifth Generation (“5G”) network, and/or may include elements of a 5G network. In some embodiments, environment 1000 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an EPC). In some embodiments, portions of environment 1000 may represent or may include a 5GC. As shown, environment 1000 may include UE 105, RAN 1010 (which may include one or more Next Generation Node Bs (“gNBs”) 1011), RAN 1012 (which may include one or more evolved Node Bs (“eNBs”) 1013), and various network functions such as Access and Mobility Management Function (“AMF”) 1015, Mobility Management Entity (“MME”) 1016, Serving Gateway (“SGW”) 1017, SMF/PGW-Control plane function (“PGW-C”) 1020, PCF/PCRF 1025, Application Function (“AF”) 1030, UPF/PGW-User plane function (“PGW-U”) 1035, UDM/HSS 1040, and Authentication Server Function (“AUSF”) 1045. Environment 1000 may also include one or more networks, such as Data Network (“DN”) 1050. Environment 1000 may include one or more additional devices or systems communicatively coupled to one or more networks (e.g., DN 1050), such as IIG 107.

The example shown in FIG. 10 illustrates one instance of each network component or function (e.g., one instance of SMF/PGW-C 1020, PCF/PCRF 1025, UPF/PGW-U 1035, UDM/HSS 1040, and/or AUSF 1045). In practice, environment 1000 may include multiple instances of such components or functions. For example, in some embodiments, environment 1000 may include multiple “slices” of a core network, where each slice includes a discrete and/or logical set of network functions (e.g., one slice may include a first instance of SMF/PGW-C 1020, PCF/PCRF 1025, UPF/PGW-U 1035, UDM/HSS 1040, and/or AUSF 1045, while another slice may include a second instance of SMF/PGW-C 1020, PCF/PCRF 1025, UPF/PGW-U 1035, UDM/HSS 1040, and/or AUSF 1045). The different slices may provide differentiated levels of service, such as service in accordance with different Quality of Service (“QoS”) parameters.

The quantity of devices and/or networks, illustrated in FIG. 10, is provided for explanatory purposes only. In practice, environment 1000 may include additional devices and/or networks, fewer devices and/or networks, different devices and/or networks, or differently arranged devices and/or networks than illustrated in FIG. 10. For example, while not shown, environment 1000 may include devices that facilitate or enable communication between various components shown in environment 1000, such as routers, modems, gateways, switches, hubs, etc. In some implementations, one or more devices of environment 1000 may be physically integrated in, and/or may be physically attached to, one or more other devices of environment 1000. Alternatively, or additionally, one or more of the devices of environment 1000 may perform one or more network functions described as being performed by another one or more of the devices of environment 1000.

Elements of environment 1000 may interconnect with each other and/or other devices via wired connections, wireless connections, or a combination of wired and wireless connections. Examples of interfaces or communication pathways between the elements of environment 1000, as shown in FIG. 10, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 10, such as Service-Based Interfaces (“SBIs”), including an Namf interface, an Nudm interface, an Npcf interface, an Nupf interface, an Nnef interface, an Nsmf interface, and/or one or more other SBIs. In some embodiments, environment 1000 may be, may include, may be implemented by, and/or may be communicatively coupled to a particular network 101. In some embodiments, one or more networks 101 may include different or differently arranged elements than environment 1000.

UE 105 may include a computation and communication device, such as a wireless mobile communication device that is capable of communicating with RAN 1010, RAN 1012, and/or DN 1050. UE 105 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a Machine-to-Machine (“M2M”) device, or the like), or another type of mobile computation and communication device. UE 105 may send traffic to and/or receive traffic (e.g., user plane traffic) from DN 1050 via RAN 1010, RAN 1012, and/or UPF/PGW-U 1035.

RAN 1010 may be, or may include, a 5G RAN that includes one or more base stations (e.g., one or more gNBs 1011), via which UE 105 may communicate with one or more other elements of environment 1000. UE 105 may communicate with RAN 1010 via an air interface (e.g., as provided by gNB 1011). For instance, RAN 1010 may receive traffic (e.g., user plane traffic such as voice call traffic, data traffic, messaging traffic, etc.) from UE 105 via the air interface, and may communicate the traffic to UPF/PGW-U 1035 and/or one or more other devices or networks. Further, RAN 1010 may receive signaling traffic, control plane traffic, etc. from UE 105 via the air interface, and may communicate such signaling traffic, control plane traffic, etc. to AMF 1015 and/or one or more other devices or networks. Additionally, RAN 1010 may receive traffic intended for UE 105 (e.g., from UPF/PGW-U 1035, AMF 1015, and/or one or more other devices or networks) and may communicate the traffic to UE 105 via the air interface.

RAN 1012 may be, or may include, a LTE RAN that includes one or more base stations (e.g., one or more eNBs 1013), via which UE 105 may communicate with one or more other elements of environment 1000. UE 105 may communicate with RAN 1012 via an air interface (e.g., as provided by eNB 1013). For instance, RAN 1012 may receive traffic (e.g., user plane traffic such as voice call traffic, data traffic, messaging traffic, signaling traffic, etc.) from UE 105 via the air interface, and may communicate the traffic to UPF/PGW-U 1035 (e.g., via SGW 1017) and/or one or more other devices or networks. Further, RAN 1012 may receive signaling traffic, control plane traffic, etc. from UE 105 via the air interface, and may communicate such signaling traffic, control plane traffic, etc. to MME 1016 and/or one or more other devices or networks. Additionally, RAN 1012 may receive traffic intended for UE 105 (e.g., from UPF/PGW-U 1035, MME 1016, SGW 1017, and/or one or more other devices or networks) and may communicate the traffic to UE 105 via the air interface.

AMF 1015 may include one or more devices, systems, Virtualized Network Functions (“VNFs”), Cloud-Native Network Functions (“CNFs”), etc., that perform operations to register UE 105 with the 5G network, to establish bearer channels associated with a session with UE 105, to hand off UE 105 from the 5G network to another network, to hand off UE 105 from the other network to the 5G network, manage mobility of UE 105 between RANs 1010 and/or gNBs 1011, and/or to perform other operations. In some embodiments, the 5G network may include multiple AMFs 1015, which communicate with each other via the N14 interface (denoted in FIG. 10 by the line marked “N14” originating and terminating at AMF 1015).

MME 1016 may include one or more devices, systems, VNFs, CNFs, etc., that perform operations to register UE 105 with the EPC, to establish bearer channels associated with a session with UE 105, to hand off UE 105 from the EPC to another network, to hand off UE 105 from another network to the EPC, manage mobility of UE 105 between RANs 1012 and/or eNBs 1013, and/or to perform other operations.

SGW 1017 may include one or more devices, systems, VNFs, CNFs, etc., that aggregate traffic received from one or more eNBs 1013 and send the aggregated traffic to an external network or device via UPF/PGW-U 1035. Additionally, SGW 1017 may aggregate traffic received from one or more UPF/PGW-Us 1035 and may send the aggregated traffic to one or more eNBs 1013. SGW 1017 may operate as an anchor for the user plane during inter-eNB handovers and as an anchor for mobility between different telecommunication networks or RANs (e.g., RANs 1010 and 1012).

SMF/PGW-C 1020 may include one or more devices, systems, VNFs, CNFs, etc., that gather, process, store, and/or provide information in a manner described herein. SMF/PGW-C 1020 may, for example, facilitate the establishment of communication sessions on behalf of UE 105. In some embodiments, the establishment of communications sessions may be performed in accordance with one or more policies provided by PCF/PCRF 1025. In some embodiments, SMF/PGW-C 1020 may be, may include, and/or may be implemented by one or more SMFs 301.

PCF/PCRF 1025 may include one or more devices, systems, VNFs, CNFs, etc., that aggregate information to and from the 5G network and/or other sources. PCF/PCRF 1025 may receive information regarding policies and/or subscriptions from one or more sources, such as subscriber databases and/or from one or more users (such as, for example, an administrator associated with PCF/PCRF 1025).

AF 1030 may include one or more devices, systems, VNFs, CNFs, etc., that receive, store, and/or provide information that may be used in determining parameters (e.g., quality of service parameters, charging parameters, or the like) for certain applications.

UPF/PGW-U 1035 may include one or more devices, systems, VNFs, CNFs, etc., that receive, store, and/or provide data (e.g., user plane data). For example, UPF/PGW-U 1035 may receive user plane data (e.g., voice call traffic, data traffic, etc.), destined for UE 105, from DN 1050, and may forward the user plane data toward UE 105 (e.g., via RAN 1010, SMF/PGW-C 1020, and/or one or more other devices). In some embodiments, multiple UPFs 1035 may be deployed (e.g., in different geographical locations), and the delivery of content to UE 105 may be coordinated via the N9 interface (e.g., as denoted in FIG. 10 by the line marked “N9” originating and terminating at UPF/PGW-U 1035). Similarly, UPF/PGW-U 1035 may receive traffic from UE 105 (e.g., via RAN 1010, RAN 1012, SMF/PGW-C 1020, and/or one or more other devices), and may forward the traffic toward DN 1050. In some embodiments, UPF/PGW-U 1035 may communicate (e.g., via the N4 interface) with SMF/PGW-C 1020, regarding user plane data processed by UPF/PGW-U 1035. In some embodiments, UPF/PGW-U 1035 may be, may include, and/or may be implemented by one or more UPFs 201 and/or 801.

UDM/HSS 1040 and AUSF 1045 may include one or more devices, systems, VNFs, CNFs, etc., that manage, update, and/or store, in one or more memory devices associated with AUSF 1045 and/or UDM/HSS 1040, profile information associated with a subscriber. AUSF 1045 and/or UDM/HSS 1040 may perform authentication, authorization, and/or accounting operations associated with the subscriber and/or a communication session with UE 105.

DN 1050 may include one or more wired and/or wireless networks. For example, DN 1050 may include an Internet Protocol (“IP”)-based PDN, a wide area network (“WAN”) such as the Internet, a private enterprise network, and/or one or more other networks. UE 105 may communicate, through DN 1050, with data servers, other UEs 105, and/or to other servers or applications that are coupled to DN 1050. DN 1050 may be connected to one or more other networks, such as a public switched telephone network (“PSTN”), a public land mobile network (“PLMN”), and/or another network. DN 1050 may be connected to one or more devices, such as content providers, applications, web servers, and/or other devices, with which UE 105 may communicate.

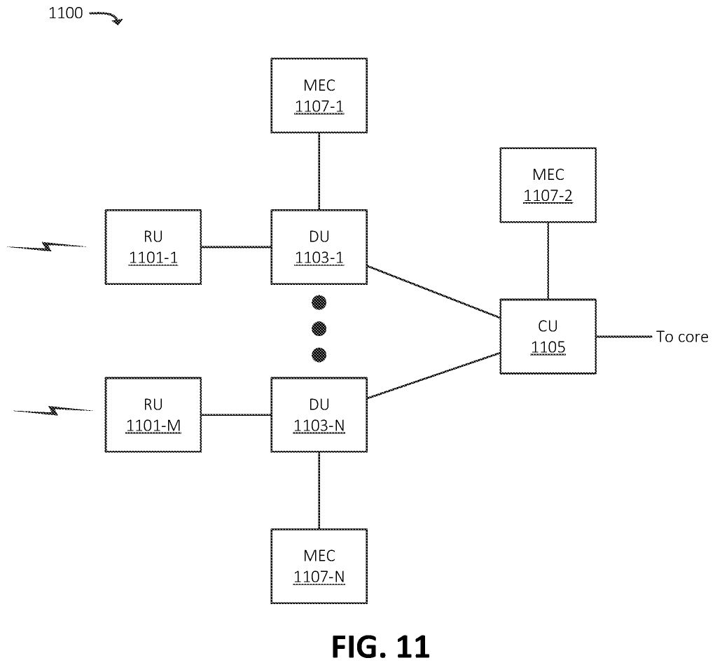

FIG. 11 illustrates an example RAN environment 1100, which may be included in and/or implemented by one or more RANs (e.g., RAN 1010, RAN 1012, or some other RAN). In some embodiments, a particular RAN may include one RAN environment 1100. In some embodiments, a particular RAN may include multiple RAN environments 1100. In some embodiments, RAN environment 1100 may correspond to a particular gNB 1011 of a 5G RAN (e.g., RAN 1010). In some embodiments, RAN environment 1100 may correspond to multiple gNBs 1011. In some embodiments, RAN environment 1100 may correspond to one or more other types of base stations of one or more other types of RANs. As shown, RAN environment 1100 may include Central Unit (“CU”) 1105, one or more Distributed Units (“DUs”) 1103-1 through 1103-N (referred to individually as “DU 1103,” or collectively as “DUs 1103”), and one or more Radio Units (“RUs”) 1101-1 through 1101-M (referred to individually as “RU 1101,” or collectively as “RUs 1101”).

CU 1105 may communicate with a core of a wireless network (e.g., may communicate with one or more of the devices or systems described above with respect to FIG. 10, such as AMF 1015 and/or UPF/PGW-U 1035). In the uplink direction (e.g., for traffic from UEs 105 to a core network), CU 1105 may aggregate traffic from DUs 1103, and forward the aggregated traffic to the core network. In some embodiments, CU 1105 may receive traffic according to a given protocol (e.g., Radio Link Control (“RLC”)) from DUs 1103, and may perform higher-layer processing (e.g., may aggregate/process RLC packets and generate Packet Data Convergence Protocol (“PDCP”) packets based on the RLC packets) on the traffic received from DUs 1103.

In accordance with some embodiments, CU 1105 may receive downlink traffic (e.g., traffic from the core network) for a particular UE 105, and may determine which DU(s) 1103 should receive the downlink traffic. DU 1103 may include one or more devices that transmit traffic between a core network (e.g., via CU 1105) and UE 105 (e.g., via a respective RU 1101). DU 1103 may, for example, receive traffic from RU 1101 at a first layer (e.g., physical (“PHY”) layer traffic, or lower PHY layer traffic), and may process/aggregate the traffic to a second layer (e.g., upper PHY and/or RLC). DU 1103 may receive traffic from CU 1105 at the second layer, may process the traffic to the first layer, and provide the processed traffic to a respective RU 1101 for transmission to UE 105.

RU 1101 may include hardware circuitry (e.g., one or more RF transceivers, antennas, radios, and/or other suitable hardware) to communicate wirelessly (e.g., via an RF interface) with one or more UEs 105, one or more other DUs 1103 (e.g., via RUs 1101 associated with DUs 1103), and/or any other suitable type of device. In the uplink direction, RU 1101 may receive traffic from UE 105 and/or another DU 1103 via the RF interface and may provide the traffic to DU 1103. In the downlink direction, RU 1101 may receive traffic from DU 1103, and may provide the traffic to UE 105 and/or another DU 1103.

One or more elements of RAN environment 1100 may, in some embodiments, be communicatively coupled to one or more Multi-Access/Mobile Edge Computing (“MEC”) devices, referred to sometimes herein simply as “MECs” 1107. For example, DU 1103-1 may be communicatively coupled to MEC 1107-1, DU 1103-N may be communicatively coupled to MEC 1107-N, CU 1105 may be communicatively coupled to MEC 1107-2, and so on. MECs 1107 may include hardware resources (e.g., configurable or provisionable hardware resources) that may be configured to provide services and/or otherwise process traffic to and/or from UE 105, via a respective RU 1101.

For example, DU 1103-1 may route some traffic, from UE 105, to MEC 1107-1 instead of to a core network via CU 1105. MEC 1107-1 may process the traffic, perform one or more computations based on the received traffic, and may provide traffic to UE 105 via RU 1101-1. In some embodiments, MEC 1107 may include, and/or may implement, some or all of the functionality described above with respect to IIG 107, AF 1030, UPF 1035, and/or one or more other devices, systems, VNFs, CNFs, etc. In this manner, ultra-low latency services may be provided to UE 105, as traffic does not need to traverse DU 1103, CU 1105, links between DU 1103 and CU 1105, and an intervening backhaul network between RAN environment 1100 and the core network.

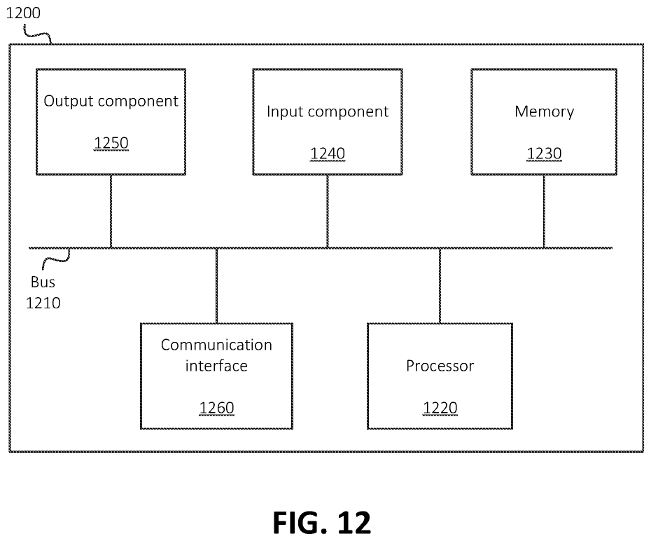

FIG. 12 illustrates example components of device 1200. One or more of the devices described above may include one or more devices 1200. Device 1200 may include bus 1210, processor 1220, memory 1230, input component 1240, output component 1250, and communication interface 1260. In another implementation, device 1200 may include additional, fewer, different, or differently arranged components.

Bus 1210 may include one or more communication paths that permit communication among the components of device 1200. Processor 1220 may include a processor, microprocessor, or processing logic that may interpret and execute instructions. In some embodiments, processor 1220 may be or may include one or more hardware processors. Memory 1230 may include any type of dynamic storage device that may store information and instructions for execution by processor 1220, and/or any type of non-volatile storage device that may store information for use by processor 1220.

Input component 1240 may include a mechanism that permits an operator to input information to device 1200 and/or other receives or detects input from a source external to input component 1240, such as a touchpad, a touchscreen, a keyboard, a keypad, a button, a switch, a microphone or other audio input component, etc. In some embodiments, input component 1240 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1250 may include a mechanism that outputs information to the operator, such as a display, a speaker, one or more light emitting diodes (“LEDs”), etc.

Communication interface 1260 may include any transceiver-like mechanism that enables device 1200 to communicate with other devices and/or systems. For example, communication interface 1260 may include an Ethernet interface, an optical interface, a coaxial interface, or the like. Communication interface 1260 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 1200 may include more than one communication interface 1260. For instance, device 1200 may include an optical interface and an Ethernet interface.

Device 1200 may perform certain operations relating to one or more processes described above. Device 1200 may perform these operations in response to processor 1220 executing software instructions stored in a computer-readable medium, such as memory 1230. A computer-readable medium may be defined as a non-transitory memory device. A memory device may include space within a single physical memory device or spread across multiple physical memory devices. The software instructions may be read into memory 1230 from another computer-readable medium or from another device. The software instructions stored in memory 1230 may cause processor 1220 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-9), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive, from a User Equipment (“UE”) via a first network, a request to establish a communication session;
determine, based on one or more attributes of the request, that the requested communication session should be established between the UE and a gateway device that is communicatively coupled to a second network; and
establish, based on the determining, the communication session between the UE and the gateway device, wherein the UE outputs communications to the gateway device via the established communication session, wherein the gateway device further forwards the communications received via the communication session to an Internet Protocol (“IP”) Multimedia Subsystem (“IMS”) core of the second network.

2. The device of claim 1, wherein the request is a first request and wherein the communication session is a first communication session, wherein the one or more processors are further configured to:
receive, from the UE, a second request to establish a second communication session;
forgo determining, based on one or more attributes of the second request, that the requested communication should be established between the UE and the gateway device communicatively coupled to the second network; and
establish, based on forgoing determining that the requested communication should be established between the UE and the gateway device, the requested second communication session between the UE and a user plane element of the first network.

3. The device of claim 2, wherein the user plane element includes at least one of:
a User Plane Function (“UPF”) of the first network, or
a Packet Data Network (“PDN”) Gateway (“PGW”) of the first network.

4. The device of claim 1, wherein the one or more attributes include at least one of:
an indication of a particular protocol,
a particular Quality of Service (“QoS”) identifier, or
a set of QoS parameters.

5. The device of claim 4,
wherein when the one or more attributes include the indication of the particular protocol, the indication of the particular protocol includes an indication of a Session Initiation Protocol (“SIP”), and
wherein when the one or more attributes include the particular QoS identifier, the particular QoS identifier includes at least one of:
a 5G QoS Identifier (“5QI”) value, or
a QoS Class Identifier (“QCI”) value.

6. The device of claim 1, wherein the gateway device is communicatively coupled to at least one of:
a User Plane Function (“UPF”) of the second network, or
a Packet Data Network (“PDN”) Gateway (“PGW”) of the second network.

7. The device of claim 1, wherein the gateway device is communicatively coupled to the second network via one or more tunnels.

8. A non-transitory computer-readable medium, storing a plurality of processor-executable instructions to:
receive, from a User Equipment (“UE”) via a first network, a request to establish a communication session;
determine, based on one or more attributes of the request, that the requested communication session should be established between the UE and a gateway device that is communicatively coupled to a second network; and
establish, based on the determining, the communication session between the UE and the gateway device, wherein the UE outputs communications to the gateway device via the established communication session, wherein the gateway device further forwards the communications received via the communication session to an Internet Protocol (“IP”) Multimedia Subsystem (“IMS”) core of the second network.

9. The non-transitory computer-readable medium of claim 8, wherein the request is a first request and wherein the communication session is a first communication session, wherein the plurality of processor-executable instructions further include processor-executable instructions to:
receive, from the UE, a second request to establish a second communication session;
forgo determining, based on one or more attributes of the second request, that the requested communication should be established between the UE and the gateway device communicatively coupled to the second network; and
establish, based on forgoing determining that the requested communication should be established between the UE and the gateway device, the requested second communication session between the UE and a user plane element of the first network.

10. The non-transitory computer-readable medium of claim 9, wherein the user plane element includes at least one of:
a User Plane Function (“UPF”) of the first network, or
a Packet Data Network (“PDN”) Gateway (“PGW”) of the first network.

11. The non-transitory computer-readable medium of claim 8, wherein the one or more attributes include at least one of:
an indication of a particular protocol,
a particular Quality of Service (“QoS”) identifier, or
a set of QoS parameters.

12. The non-transitory computer-readable medium of claim 11,
wherein when the one or more attributes include the indication of the particular protocol, the indication of the particular protocol includes an indication of a Session Initiation Protocol (“SIP”), and
wherein when the one or more attributes include the particular QoS identifier, the particular QoS identifier includes at least one of:
a 5G QoS Identifier (“5QI”) value, or
a QoS Class Identifier (“QCI”) value.

13. The non-transitory computer-readable medium of claim 8, wherein the gateway device is communicatively coupled to at least one of:
a User Plane Function (“UPF”) of the second network, or
a Packet Data Network (“PDN”) Gateway (“PGW”) of the second network.

14. The non-transitory computer-readable medium of claim 8, wherein the gateway device is communicatively coupled to the second network via one or more tunnels.

15. A method, comprising:
receiving, from a User Equipment (“UE”) via a first network, a request to establish a communication session;
determining, based on one or more attributes of the request, that the requested communication session should be established between the UE and a gateway device that is communicatively coupled to a second network; and
establishing, based on the determining, the communication session between the UE and the gateway device, wherein the UE outputs communications to the gateway device via the established communication session, wherein the gateway device further forwards the communications received via the communication session to an Internet Protocol (“IP”) Multimedia Subsystem (“IMS”) core of the second network.

16. The method of claim 15, wherein the request is a first request and wherein the communication session is a first communication session, the method further comprising:
receiving, from the UE, a second request to establish a second communication session;
forgoing determining, based on one or more attributes of the second request, that the requested communication should be established between the UE and the gateway device communicatively coupled to the second network; and
establishing, based on forgoing determining that the requested communication should be established between the UE and the gateway device, the requested second communication session between the UE and a user plane element of the first network, wherein the user plane element includes at least one of:
a User Plane Function (“UPF”), or
a Packet Data Network (“PDN”) Gateway (“PGW”).

17. The method of claim 15, wherein the one or more attributes include at least one of:
an indication of a particular protocol,
a particular Quality of Service (“QoS”) identifier, or
a set of QoS parameters.

18. The method of claim 17,
wherein when the one or more attributes include the indication of the particular protocol, the indication of the particular protocol includes an indication of a Session Initiation Protocol (“SIP”), and
wherein when the one or more attributes include the particular QoS identifier, the particular QoS identifier includes at least one of:
a 5G QoS Identifier (“5QI”) value, or
a QoS Class Identifier (“QCI”) value.

19. The method of claim 15, wherein the gateway device is communicatively coupled to at least one of:
a User Plane Function (“UPF”) of the second network, or
a Packet Data Network (“PDN”) Gateway (“PGW”) of the second network.

20. The method of claim 15, wherein the gateway device is communicatively coupled to the second network via one or more tunnels.
